(19) United States
(12) Patent Application Publication
(10) Pub. No.: US 2026/0072700 A1
(43) Pub. Date: Mar. 12, 2026

(54) ELECTRONIC DEVICE FOR IDENTIFYING AUDIO CIRCUIT CONNECTED TO PROCESSOR, AND METHOD THEREFOR

(71) Applicant: Samsung Electronics Co., Ltd., Suwon-si (KR)

(72) Inventors: Soonkyu LEE, Suwon-si (KR); Min LEE, Suwon-si (KR); Jinyoung KIM, Suwon-si (KR); Hanki YOON, Suwon-si (KR); Jongkwang JUNG, Suwon-si (KR)

(21) Appl. No.: 19/384,155

(22) Filed: Nov. 10, 2025

Related U.S. Application Data
(63) Continuation of application No. PCT/KR2024/008866, filed on Jun. 26, 2024.

(30) Foreign Application Priority Data
Jul. 5, 2023 (KR) 10-2023-0087391

(51) Int. Cl. G06F 9/4401; G06F 3/16

(52) U.S. Cl. CPC G06F 9/4411; G06F 3/162

(57) ABSTRACT

An electronic device is provided. The electronic device includes a processor, a plurality of audio circuits connected to the processor, and memory configured to store instructions. The instructions, when executed by the processor, instruct the processor to initialize the plurality of audio circuits in a first state while booting the electronic device. Each of the plurality of audio circuits is switched to a second state different from the first state on the basis of initialization. The instructions, when executed by the processor, instruct the processor to, on the basis of identifying at least one audio circuit maintained in the first state among the plurality of audio circuits, store, in the memory, log information including information about the identified at least one audio circuit.

### CROSS-REFERENCE TO RELATED APPLICATION(S)

This application is a continuation application, claiming priority under 35 U.S.C. § 365 (c), of an International application No. PCT/KR2024/008866, filed on Jun. 26, 2024, which is based on and claims the benefit of a Korean patent application number 10-2023-0087391, filed on Jul. 5, 2023, in the Korean Intellectual Property Office, the disclosure of which is incorporated by reference herein in its entirety.

### BACKGROUND

### 1. Field

The disclosure relates to an electronic device and a method for identifying an audio circuit connected to a processor.

### 2. Description of Related Art

To support various audio-related functions, an electronic device may include one or more audio circuits. The functions may include recording audio, playing audio, and encoding and/or decoding audio data. The circuits for supporting the functions may be electrically connected to a processor of the electronic device, in the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for identifying an audio circuit connected to a processor.

Additional aspects will be set forth in part in the description which follows and, in part, will be apparent from the description, or may be learned by practice of the presented embodiments.

In accordance with an aspect of the disclosure, an electronic device is provided. The electronic device includes a plurality of audio circuits, memory including one or more storage media storing instructions, and at least one processor including processing circuitry communicatively coupled to the plurality of audio circuits and the memory, wherein the instructions, when executed by the at least one processor individually or collectively, cause the electronic device to perform initialization of the plurality of audio circuits in a first state while booting up the electronic device, wherein each of the plurality of audio circuits are switched to a second state different from the first state, based on the initialization, and based on identifying, among the plurality of audio circuits, at least one audio circuit of which a state is maintained in the first state, store, in the memory, log information including information with respect to the identified at least one audio circuit.

In accordance with another aspect of the disclosure, a method performed by an electronic device is provided. The method includes performing, by the electronic device, initialization of a plurality of audio circuits in a first state while booting up the electronic device, wherein each of the plurality of audio circuits of the electronic device are switched to a second state different from the first state, based on the initialization, and based on identifying, among the plurality of audio circuits, at least one audio circuit of which a state is maintained in the first state, storing, by the electronic device, in memory of the electronic device, log information including information with respect to the identified at least one audio circuit.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The electronic device including memory and a plurality of audio circuits, the operations include performing initialization of the plurality of audio circuits in a first state while booting up the electronic device, wherein each of the plurality of audio circuits are switched to a second state different from the first state, based on the initialization, and based on identifying, among the plurality of audio circuits, at least one audio circuit of which a state is maintained in the first state, storing, in the memory, log information including information with respect to the identified at least one audio circuit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an electronic device according to an embodiment of the disclosure;

FIG. 2 illustrates an example of a flowchart of an electronic device according to an embodiment of the disclosure;

FIG. 3 illustrates an example of a block diagram for software applications executed by a processor of an electronic device according to an embodiment of the disclosure;

FIG. 4 illustrates an example of a block diagram for software applications executed by a processor of an electronic device according to an embodiment of the disclosure;

FIG. 5 illustrates an example of an operation of an electronic device for storing log information according to an embodiment of the disclosure;

FIG. 6 illustrates an example of a screen displayed by an electronic device according to an embodiment of the disclosure;

FIGS. 7A and 7B illustrate an example of a flowchart of an electronic device according to various embodiments of the disclosure;

FIG. 8 is a block diagram of an electronic device in a network environment according to an embodiment of the disclosure; and

FIG. 9 is a block diagram of an audio module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments of the disclosure and terms used herein are not intended to limit the technology described in the disclosure to specific embodiments, and should be understood to include various modifications, equivalents, or substitutes of the corresponding embodiment. In relation to the description of the drawings, a reference numeral may be used for a similar component. In the disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the disclosure may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

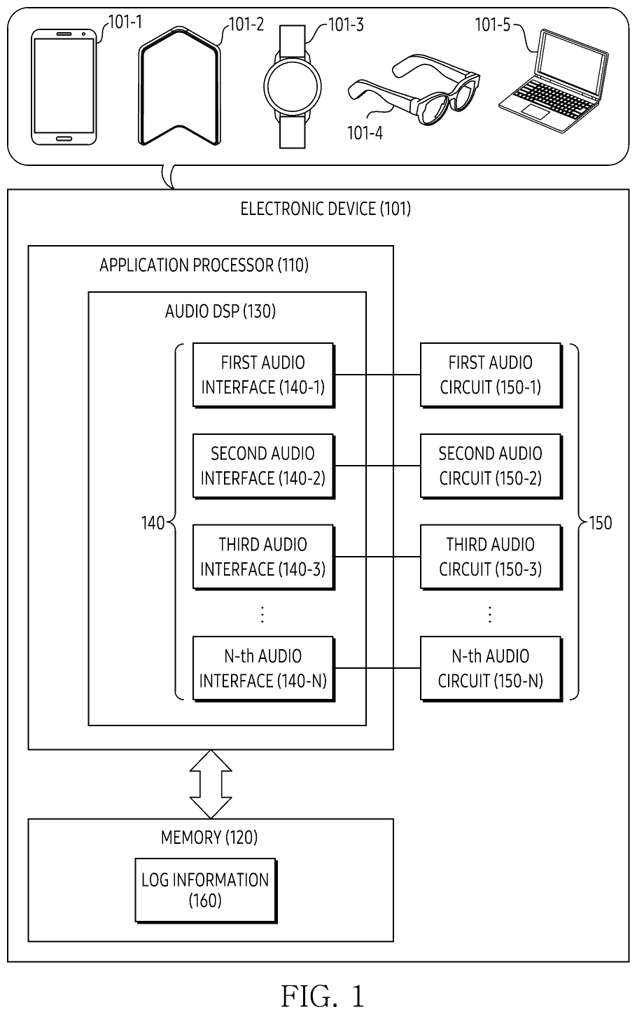

FIG. 1 illustrates a block diagram of an electronic device according to an embodiment of the disclosure. In an embodiment, an electronic device 101 may be referred to as a terminal (or a user terminal). The terminal may include, for example, a smartphone (e.g., an electronic device 101-1), a foldable phone (e.g., an electronic device 101-2), a smartpad, and/or a tablet PC. The terminal may include a smart accessory such as a smartwatch (e.g., an electronic device 101-3) and/or a head-mounted device (HMD) (e.g., an electronic device 101-4). The terminal may include, for example, a personal computer (PC) such as a laptop (e.g., an electronic device 101-5) and a desktop.

Referring to FIG. 1, according to an embodiment, one or more hardware included in the electronic device 101 are illustrated by different blocks. According to an embodiment, the electronic device 101 may include an application processor (AP) 110 and/or memory 120. The application processor 110 may include circuitry for processing data based on one or more instructions. A hardware component for processing data may include, for example, an arithmetic and logic unit (ALU), a floating point unit (FPU), a field programmable gate array (FPGA), and/or a central processing unit (CPU). The number of the application processor 110 included in the electronic device 101 may be one or more. For example, the application processor 110 may have a multi-core processor structure such as a dual core, a quad core, or a hexa core. In an embodiment, the application processor 110 may be referred to as a processor.

According to an embodiment, the memory 120 of the electronic device 101 may include hardware for storing data and/or instructions inputted to and/or outputted from the application processor 110. The memory 120 may include, for example, volatile memory such as random-access memory (RAM), and/or non-volatile memory such as read-only memory (ROM). The volatile memory may include, for example, at least one of a dynamic RAM (DRAM), a static RAM (SRAM), a Cache RAM, or a pseudo SRAM (PSRAM). The non-volatile memory may include, for example, at least one of a programmable ROM (PROM), an erasable PROM (EPROM), an electrically erasable PROM (EEPROM), flash memory, a hard disk, a compact disk, a solid state drive (SSD), or an embedded multi media card (eMMC).

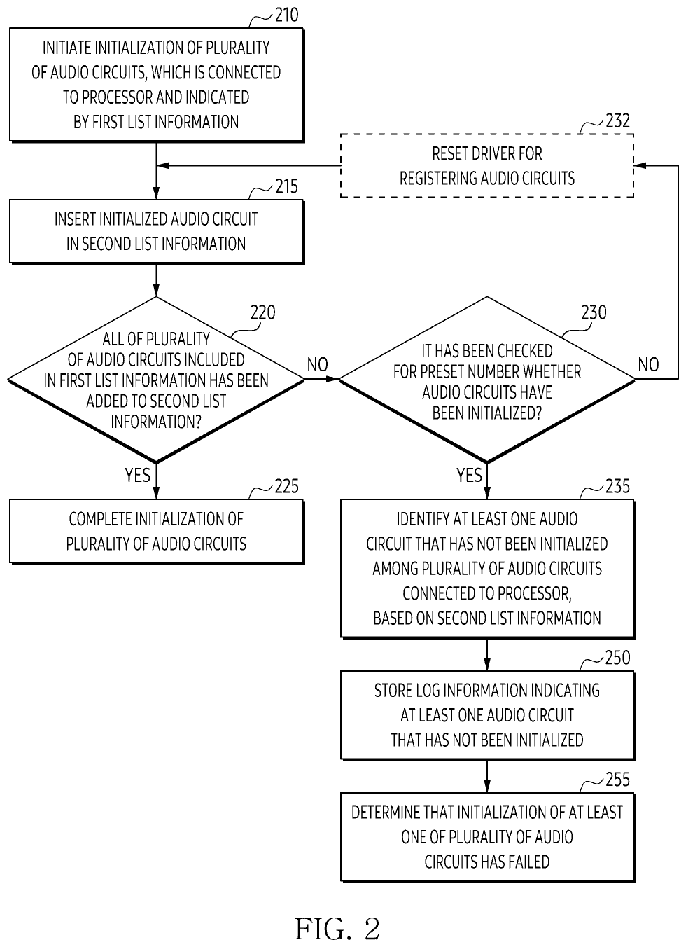

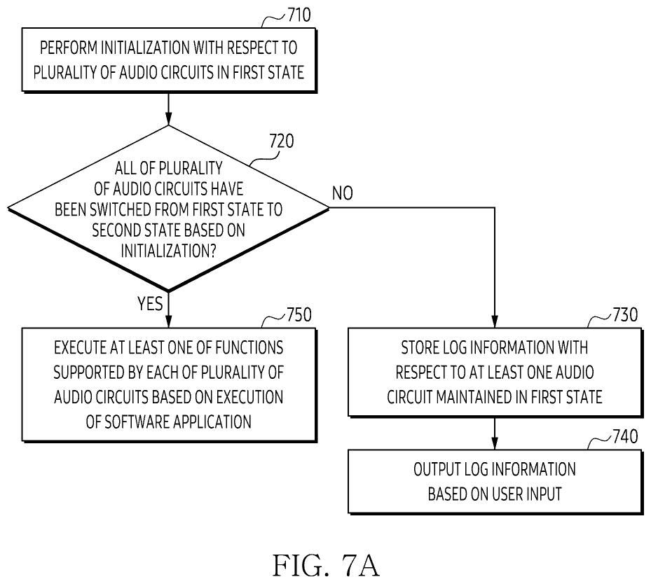

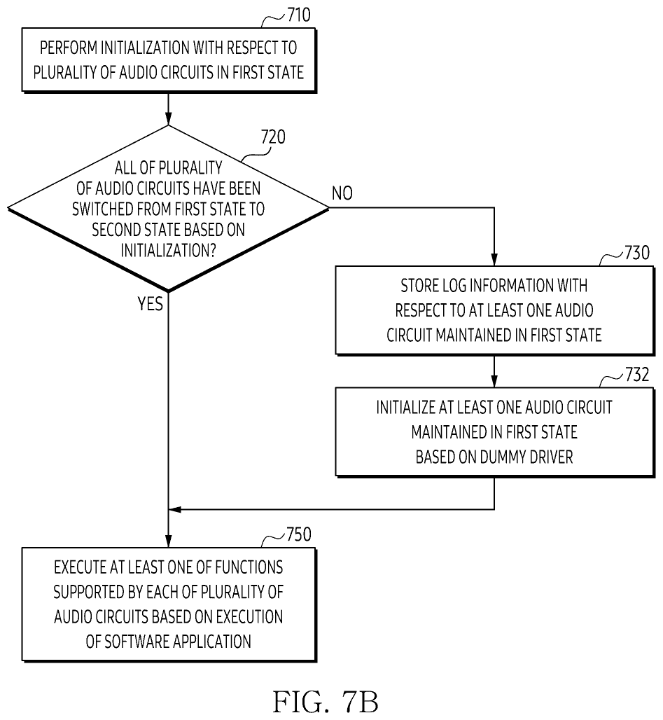

According to an embodiment, in the memory 120 of the electronic device 101, one or more instructions (or commands) indicating a computation and/or an operation to be performed on data by the application processor 110 may be stored. A set of one or more instructions may be referred to as firmware, an operating system, a process, a routine, a sub-routine, a software application, and/or an application. For example, the electronic device 101 and/or the application processor 110 may perform at least one of operations of FIG. 2 and/or FIGS. 7A and 7B, when a set of a plurality of instructions distributed in a form of an operating system, firmware, a driver, and/or an application is executed. Hereinafter, that an application is installed in the electronic device 101 may mean that one or more instructions provided in a form of an application are stored in the memory 120 of the electronic device 101, and that the one or more applications are stored as a format (e.g., a file having an extension preset by an operating system of the electronic device 101) executable by the application processor 110 of the electronic device 101.

Referring to FIG. 1, according to an embodiment, the application processor 110 of the electronic device 101 may include an audio digital signal processor (DSP) 130. The audio DSP 130 may be included in the application processor 110 for signal processing related to audio. For example, the audio DSP 130 may be included in the application processor 110 as an auxiliary processor for audio. The application processor 110 may be electrically connected to a plurality of audio circuits 150 included in the electronic device 101 through the audio DSP 130. Hereinafter, that circuits are electrically connected may mean that a wired signal path is established between two circuits. Electrical connection between circuits may include a direct connection and/or an indirect connection between the circuits. For example, one or more circuit elements for transmission of an electrical signal may be positioned between circuits that are electrically connected. Hereinafter, that circuits are connected may mean that the circuits are electrically connected. To be connected to the plurality of audio circuits 150, the audio DSP 130 may include a plurality of audio interfaces 140. For example, the application processor 110 and the plurality of audio circuits 150 may be connected to each other through the plurality of audio interfaces 140. Hereinafter, a sound card of the electronic device 101 may mean a group of the audio DSP 130 and the plurality of audio circuits 150.

Referring to FIG. 1, although an embodiment in which the audio DSP 130 is included in the application processor 110 is illustrated, the embodiment is not limited thereto. For example, the audio DSP 130 may be positioned outside (e.g., on a printed circuit board (PCB) on which the application processor 110 is positioned) the application processor 110. In a case positioned outside the application processor 110, the audio DSP 130 may be electrically connected directly to the plurality of audio circuits 150 through the plurality of audio interfaces 140-1, 140-2, 140-3, . . . 140-N, and/or may be electrically connected to the plurality of audio circuits 150 through the application processor 110.

According to an embodiment, the plurality of audio circuits 150 of the electronic device 101 may be connected to the application processor 110 to support different functions related to audio. For example, a first audio circuit 150-1 may include circuits (e.g., an analog-to-digital converter (ADC), a digital-to-analog converter (DAC), a filter with respect to an audio signal, or gain setting circuitry) for signal processing of an audio signal. For example, a second audio circuit 150-2 may include amplifying circuitry for amplifying an electrical signal (e.g., an audio signal) to be transmitted to a speaker of the electronic device 101. For example, a third audio circuit 150-3 may include a haptic actuator for outputting a vibration notification. For example, an N-th audio circuit 150-N may include communication circuitry based on Bluetooth. The embodiment is not limited thereto, and for example, the plurality of audio circuits 150 may include a microphone. The microphone may be electrically connected directly to the application processor 110 through an audio interface, or may be electrically connected indirectly to the application processor 110 through an audio circuit.

According to an embodiment, the plurality of audio interfaces 140 included in the application processor 110 and/or the audio DSP 130 of the electronic device 101 may be designed based on a standard for exchanging audio data in order to communicate with an audio circuit 150 corresponding to an audio interface. The standard may include integrated interchip sound (12S), serial low-power inter-chip media bus (SLIMbus), and/or SoundWire. The embodiment is not limited thereto, and at least one of the plurality of audio interfaces 140 may be designed based on a standard such as Mobile Industry Processor Interface (MIPI) and/or general purpose input output (GPIO). The plurality of audio interfaces 140 may include one or more circuits that are included in or formed in the application processor 110, in order to be electrically connected to the plurality of audio circuits 150.

According to an embodiment, the electronic device 101 may perform initialization with respect to the plurality of audio circuits 150 in order to execute a function related to audio. Initializing an audio circuit may mean changing a state of the audio circuit to a state controllable by the application processor 110 or the audio DSP 130 by controlling the audio circuit. Hereinafter, an activated state (or enabled state) of an audio circuit may include a state of the audio circuit that is controllable by the application processor 110 or the audio DSP 130. According to an embodiment, the activated state of an audio circuit may include a state in which initialization of a driver application corresponding to the audio circuit is completed. The activated state of an audio circuit may include a state in which the audio circuit, in response to an application programmable interface (API) corresponding to the audio circuit, is capable of executing a function specified by the API. For example, the application processor 110 may execute a function of an audio circuit in the activated state based on execution of a software application. The activated state of an audio circuit may include an idle state of the audio circuit. The activated state may be referred to as a wake-up state, an idle state, or a turn-on state. The activated state of the audio circuit may include a state in which a power signal exceeding a preset voltage is provided to the audio circuit.

In an embodiment, a deactivated state (or disabled state) of an audio circuit may include another state of the audio circuit that is different from the activated state. The deactivated state of an audio circuit may include a state of the audio circuit that is uncontrollable by the application processor 110 or the audio DSP 130. For example, an audio circuit in the deactivated state may not respond to a signal transmitted from the application processor 110 or the audio DSP 130 through an audio interface. For example, the deactivated state of an audio circuit may include a state in which the audio circuit, in response to an API corresponding to the audio circuit, does not execute a function specified by the API. The deactivated state of an audio circuit may be referred to as a sleep state. The deactivated state of the audio circuit may include a state in which a power signal below a preset voltage is provided to the audio circuit, and/or a state in which a provision of the power signal to the audio circuit is restricted. The deactivated state of the audio circuit may include a state in which initialization of the audio circuit is at least temporarily interrupted due to a fault, damage, and/or burnout. For example, the deactivated state of an audio circuit may include a state in which the audio circuit is substantially not operating. For example, the deactivated state may include a state in which an audio circuit is electrically deactivated as at least a portion of the audio circuit and/or at least one of circuit elements of the audio circuit are powered off. The deactivated state may be referred to as a turn-off state.

According to an embodiment, the application processor 110 of the electronic device 101 may perform booting with respect to the electronic device 101. According to an embodiment, booting up the electronic device 101 may mean making at least one or more hardware included in the electronic device 101 to be in a state controllable by software of the electronic device 101 by activating hardware (or circuits) included in the electronic device 101. Booting up the electronic device 101 may include an operation of identifying a state of the hardware included in the electronic device 101. The operation of identifying a state of the hardware may include an operation of detecting, recognizing, sensing, and/or determining the state of the hardware. According to an embodiment, booting up the electronic device 101 may include a task of loading an operating system (e.g., Android OS) included in the memory of the electronic device 101 so as to be executable by the electronic device 101 and/or the application processor 110.

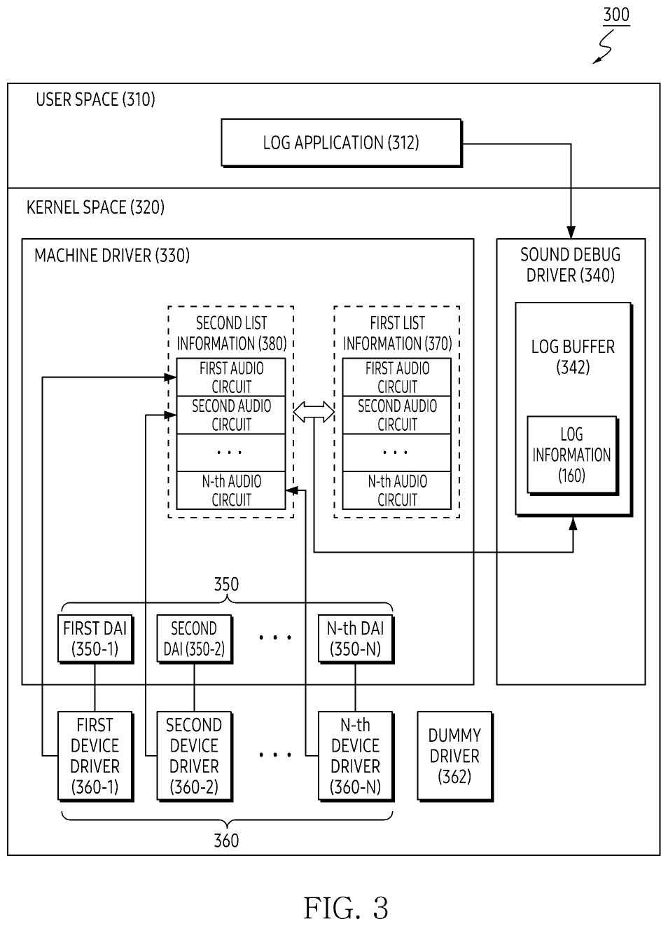

According to an embodiment, the application processor 110 may perform initialization of the plurality of audio circuits 150 in the deactivated state while booting up the electronic device 101. Each of the plurality of audio circuits 150 may be switched from the deactivated state to the activated state based on the initialization. According to an embodiment, the operation of initializing the plurality of audio circuits 150 may include an operation of making the plurality of audio circuits 150 to be in a state available by the application processor 110 and/or the audio DSP 130 by driving the plurality of audio circuits 150 based on an initial parameter and/or preset parameters. The operation of initializing the plurality of audio circuits 150 may include an operation of loading a device driver (e.g., a plurality of device drivers 360 of FIG. 3) corresponding to each of the plurality of audio circuits 150 based on system software (e.g., a kernel) executed by the application processor 110.

According to an embodiment, the application processor 110 of the electronic device 101 may identify, among the plurality of audio circuits 150, at least one audio circuit maintained in the deactivated state independently of initialization of the plurality of audio circuits 150. For example, the application processor 110 may identify whether each of the plurality of audio circuits 150 has been switched to the activated state based on the initialization. Based on identifying the at least one audio circuit maintained in the deactivated state despite the initialization, the application processor 110 may store log information 160 including information with respect to the identified at least one audio circuit in the memory 120. The log information 160 may indicate that the identified at least one audio circuit is different from an audio circuit accessible by the initialization. For example, the application processor 110 may store, in the memory 120, the log information 160 indicating at least one audio circuit corresponding to the deactivated state among the plurality of audio circuits 150. For example, the log information 160 may include a list of at least one audio circuit corresponding to the deactivated state. According to an embodiment, in terms of solving an issue caused by an audio circuit in the deactivated state, the log information 160 may be referred to as debug information and/or a debug file. For example, the application processor 110 may identify an audio circuit in which an error and/or fault has occurred by comparing information indicating at least one audio circuit corresponding to the deactivated state among the plurality of audio circuits 150 with information with respect to an audio circuit that may be initially accessed.

As described above, according to an embodiment, the electronic device 101 may individually check the plurality of audio circuits 150 while booting up the electronic device 101. For example, the electronic device 101 may identify whether each of the plurality of audio circuits 150 is switched to the activated state based on the initialization. When an audio circuit in the deactivated state, different from the activated state, is identified among the plurality of audio circuits 150, the electronic device 101 may store, in the log information 160, information indicating the identified audio circuit. The log information 160 may be used for maintenance of the electronic device 101.

Hereinafter, referring to FIG. 2, an example of an operation performed by the electronic device 101 and/or the application processor 110 for initialization of the plurality of audio circuits 150, according to an embodiment, is described.

FIG. 2 illustrates an example of a flowchart of an electronic device according to an embodiment of the disclosure. The electronic device 101 and/or the application processor 110 of FIG. 1 may perform at least one of operations described with reference to FIG. 2.

Referring to FIG. 2, in operation 210, a processor of the electronic device according to an embodiment may initiate initialization of at least one audio circuit among a plurality of audio circuits (e.g., the plurality of audio circuits 150 of FIG. 1), which is connected to the processor and indicated by first list information. Hereinafter, an audio circuit being indicated by list information and/or corresponding to list information may mean that a parameter for specifying the audio circuit (e.g., an identifier, a serial number, and/or a name assigned to the audio circuit) is included in the list information. The first list information may be stored in memory (e.g., the memory 120 of FIG. 1) of the electronic device 101. The first list information may correspond to at least a portion of hardware and/or circuits included in the electronic device. According to an embodiment, the operation 210 of FIG. 2 may be performed by a processor (e.g., the application processor 110 of FIG. 2) of the electronic device 101 while booting up the electronic device 101. The embodiment is not limited thereto, and the processor of the electronic device 101 may be performed by the processor of the electronic device 101 while performing a state and/or an operation (e.g., an operation related to a recovery and/or diagnosis of the electronic device 101) different from booting.

According to an embodiment, the first list information may include information for identifying the plurality of audio circuits 150 included in the electronic device 101 (e.g., names assigned to each of the plurality of audio circuits 150). According to an embodiment, based on the first list information, the processor may execute a system application (e.g., a device driver) corresponding to each of the plurality of audio circuits.

In an embodiment, based on the execution of a device driver, the processor may execute a function for initialization with respect to at least one of the audio circuits. For example, the processor may perform initialization with respect to each of the plurality of audio circuits or may perform initialization with respect to all of the audio circuits. For example, the processor may perform initialization with respect to the plurality of audio circuits individually and/or independently. According to an embodiment, the function may include a function of providing a power signal set by the device driver to each of the plurality of audio circuits. According to an embodiment, the function may include a function for activating an audio interface between the plurality of audio circuits and the processor. For example, to activate the audio interface, the processor may adjust a clock of the audio interface to a clock specified by the device driver. For example, to activate the audio interface, the processor may transmit and receive signals related to audio with the device driver by transmitting an electrical signal to the audio interface. The electrical signal transmitted and/or received between the processor and an audio circuit may be referred to as a control signal, a data signal, and/or an audio signal.

In an embodiment, while the plurality of audio circuits is being initialized based on the operation 210, the processor of the electronic device may perform initialization with respect to a device driver (e.g., a machine driver 330 of FIG. 3) for a sound card (e.g., the group of the audio DSP 130 and the plurality of audio circuits 150 of FIG. 1) of the electronic device. For example, the processor may perform initialization and/or loading with respect to a plurality of device drivers 360 and/or the machine driver 330 of FIG. 3. Based on the device driver for the sound card, the processor may electrically or physically bind each of the plurality of audio circuits to a plurality of audio interfaces (e.g., the plurality of audio interfaces 140 of FIG. 1).

Referring to FIG. 2, in operation 215, the processor of the electronic device according to an embodiment may add information with respect to an initialized audio circuit (e.g., text indicating a name assigned to the audio circuit) to second list information. For example, the processor having identified an initialized audio circuit based on the operation 210 may perform the operation 215 to add information with respect to the initialized audio circuit (e.g., a name uniquely assigned to the audio circuit, a serial number, or an ID assigned to the audio circuit, and the like) to the second list information. According to an embodiment, in terms of a list of initialized components, the second list information may be referred to as a component list. Based on the operation 215, information with respect to at least one audio circuit switched to an activated state may be included in and/or accumulated in the second list information.

Referring to FIG. 2, in operation 220, the processor of the electronic device according to an embodiment may identify whether information with respect to all of the plurality of audio circuits (e.g., audio circuits whose names are stored in the first list information) related to the first list information has been added to the second list information. The processor may perform the operations 215 and 220 of FIG. 2 based on initialization of each of the plurality of audio circuits. In an embodiment, the processor may identify at least one audio circuit indicated by the first list information among the second list information and the first list information by comparing the first list information and the second list information. For example, information with respect to a specific audio circuit being included only in the first list information among the second list information and the first list information may mean that the specific audio circuit corresponds to an uninitialized state (e.g., a deactivated state). For example, in a case in which all of the plurality of audio circuits indicated by the first list information are included in the second list information (220-YES), the processor may perform operation 225. In a case in which information with respect to at least one of the audio circuits indicated by the first list information is not included in the second list information, or when information with respect to all of the audio circuits included in the first list information is not included in the second list information (220-NO), the processor may perform operation 230. For example, the processor may perform the operation 230 before information with respect to all of the audio circuits indicated by the first list information is included in the second list information.

Referring to FIG. 2, in the operation 225, the processor of the electronic device according to an embodiment may complete the initialization of the plurality of audio circuits. In a state of performing the operation 225, since information with respect to all of the plurality of audio circuits has been added to the second list information, all of the plurality of audio circuits may correspond to the activated state based on the initialization. After the operation 225, the processor may complete the booting of the electronic device. Based on the operation 225, the processor may complete registration and/or activation of the sound card. Registering the sound card may mean changing a state of hardware (e.g., the audio DSP 130 and the plurality of audio circuits 150 of FIG. 1) of the electronic device related to the sound card into a state controllable by a software application executed by the processor. For example, based on the completion of initialization in the operation 225, the processor may control all of the plurality of audio signals in the activated state. For example, after the operation 225, the processor may control at least one of the plurality of audio circuits, and/or an audio DSP (e.g., the audio DSP 130 of FIG. 1) based on the execution of the software application. For example, based on the operation 225, the processor may not store log information (e.g., the log information 160 of FIG. 1). For example, the log information may not be changed and/or may not be generated by the operation 225 of FIG. 2.

Referring to FIG. 2, in the operation 230, the processor of the electronic device according to an embodiment may identify whether it has been checked for a preset number whether the audio circuits have been initialized. For example, the processor may repeatedly perform an operation of comparing the first list information of the operation 210 and the second list information of the operation 215, for the preset number according to the operation 230. The operation 230 of comparing the first list information and the second list information may be performed, based on the operation 220, in a state in which all information with respect to the audio circuits indicated by the first list information is not included in the second list information.

For example, based on identifying an audio circuit in the deactivated state among the plurality of audio circuits, the processor may repeatedly perform checking whether the audio circuits are initialized based on a retry counter configured to be decreased by a preset number. For example, the processor may perform operation 232 before checking whether the audio circuits are initialized for the preset number (or when checking whether the audio circuits are initialized have been performed fewer than the preset number) (230-NO). For example, in a case in which at least one audio circuit has not been initialized and when checking whether the audio circuits are initialized have been performed fewer than the preset number (230-NO), the processor may perform the operation 232. In the operation 232, according to an embodiment, the processor of the electronic device may reset a driver (e.g., the machine driver 330 of FIG. 3) for registering the audio circuits. For example, the processor may perform the operations 215 and 220 of FIG. 2 by resetting a driver, among the drivers loaded based on the operation 210, loaded for comparing the first list information and the second list information for the registration of the audio circuits. For example, when the number of checks on whether the audio circuits are initialized is less than the preset number according to the operation 230, the processor may re-perform a machine driver initialization process based on the operations 215 and 220. For example, the machine driver initialization may be a sound card registration process. According to an embodiment, the processor may perform the operation 230 of FIG. 2 based on a retry counter that starts from the preset number and includes a count that gradually decreases. For example, the retry counter increases according to the number of attempts to initialize an audio circuit, and when it is determined that the counter has checked whether the audio circuits are initialized for the preset number, the processor may perform operation 235. When the initialization of the audio circuit has been attempted for the preset number (or more than the preset number), but the at least one audio circuit has not been initialized (230-YES), the processor may perform the operation 235. For example, while booting up the electronic device, when the state of the at least one audio circuit maintains the deactivated state despite having repeatedly checked whether the audio circuits have been initialized for more than the preset number, the processor may perform the operation 235.

Referring to FIG. 2, in the operation 235, the processor of the electronic device according to an embodiment may identify at least one audio circuit that has not been initialized among the plurality of audio circuits connected to the processor, based on the second list information. For example, the processor may identify one or more audio circuits indicated by the second list information among the audio circuits indicated by the first list information. According to an embodiment, among the audio circuits of the operation 210, an audio circuit included in both the first list information and the second list information may be an audio circuit in the activated state, for which initialization has been completed. Among the audio circuits of the operation 210, at least one audio circuit indicated by the first list information among the second list information or the first list information may be at least one audio circuit in the deactivated state, that has not been initialized. In terms of comparison with the second list information, the first list information may be referred to as a check list. The processor may, by searching in the second list information for each of the audio circuits indicated by the first list information, identify whether information with respect to each of the audio circuits is included in the second list information. Among the audio circuits indicated by the first list information, an audio circuit not indicated by the second list information may be an audio circuit that has not been initialized.

Referring to FIG. 2, in operation 250, the processor of the electronic device according to an embodiment may store log information indicating the at least one audio circuit that has not been initialized. For example, the processor may store text indicating the at least one audio circuit maintained in the deactivated state after the initialization in the operation 210, in the log information. The at least one audio circuit that has not been initialized may maintain the deactivated state due to a defect and/or fault based on the operation 210. Based on the operation 250, the processor may check for a fault with respect to the plurality of audio circuits included in the electronic device while booting up the electronic device or in a specific situation (e.g., reception of an audio circuit check command, diagnosis command, and the like). According to an embodiment, based on the operation 250, the processor may obtain log information indicating at the least one audio circuit that has not been initialized, independently of a software application performed to diagnose an audio circuit after booting. Based on the log information, the processor may guide a repair with respect to at least one audio circuit that has not been initialized.

Referring to FIG. 2, in operation 255, the processor of the electronic device according to an embodiment may determine that initialization of at least one of the plurality of audio circuits has failed, based on the first list information and/or the second list information. After the operation 255, when the operation 255 has been performed while booting up the electronic device, the processor may complete the booting of the electronic device. In an embodiment, the processor performing the operation 255 may cease registration and/or activation of an entire sound card of the electronic device, which includes at least one audio circuit in the deactivated state, or of at least one sound card. For example, after the operation 255, execution of a function related to audio based on an audio DSP and/or the plurality of audio circuits included in the electronic device may be restricted. The embodiment is not limited thereto, and the processor may support execution of a function for another audio circuit different from the at least one audio circuit identified based on the operation 235. After the operation 255, the processor may display a user interface (UI) that guides output of the log information stored based on the operation 250, through a display.

The operation of the electronic device described with reference to FIG. 2 may be performed based on one or more software applications installed in the electronic device. Hereinafter, with reference to FIG. 3, an example of one or more software applications included in the electronic device for performing the operations of FIG. 2 is described.

FIG. 3 illustrates an example of a block diagram for software applications executed by a processor of an electronic device according to an embodiment of the disclosure. In a block diagram 300, the electronic device 101 and/or the application processor 110 of FIG. 1 may perform at least one of operations described with reference to FIG. 3. The operation of the electronic device described with reference to FIG. 3 may be related to the operations of FIG. 2.

Referring to FIG. 3, according to an embodiment, software applications installed in the electronic device may be classified into a user space 310 and a kernel space 320. A software application (e.g., a log application 312) installed in the electronic device to directly interact with a user of the electronic device may be classified as software executed in the user space 310. According to an embodiment, at least one software application (e.g., a machine driver 330, a sound debug driver 340, and/or a plurality of device drivers 360) installed in the electronic device to support control of the electronic device based on a software application classified as software executed in the user space 310 may be classified as software executed in the kernel space 320.

Referring to FIG. 3, according to an embodiment, the processor (e.g., the application processor 110 of FIG. 1) of the electronic device may execute the device drivers 360 that respectively correspond to a plurality of audio circuits (e.g., the plurality of audio circuits 150 of FIG. 1) included in the electronic device. A device driver may be installed in the electronic device to control an audio circuit through the processor. For example, based on a device driver, the processor may generate a control signal to be transmitted to the audio circuit. For example, based on a device driver, the processor may identify or process information included in a data signal transmitted from the audio circuit.

Referring to FIG. 3, the machine driver 330 executed by the processor of the electronic device may include instructions for registering a sound card (e.g., the group of the audio DSP 130 and the plurality of audio circuits 150 of FIG. 1) included in the electronic device. According to an embodiment, in terms of correspondence to the sound card, the machine driver 330 may be referred to as a sound card driver. According to an embodiment, the machine driver 330 may include digital audio interfaces (DAIs) 350, which correspond to connection information with respect to audio interfaces (e.g., the plurality of audio interfaces 140 of FIG. 1) connected to the plurality of audio circuits. According to an embodiment, audio devices may be connected through the DAIs, controlled by a driver of each audio device, and capable of transmitting and receiving audio data between the processor and the audio device. The connection information may include at least one of information with respect to an audio interface between the processor and an audio circuit (e.g., a type of the audio interface), a name of the audio circuit corresponding to the connection information, a format of audio data transmitted to or received from the audio circuit, or a function (or API) to be executed when the transmission of the audio data is initiated or terminated. The DAIs 350 may include a data structure, which is formed in memory 120 and includes the connection information.

In an embodiment, based on execution of the machine driver 330, the processor may identify first list information 370 indicating all audio circuits included in the electronic device. Based on execution of the machine driver 330, the processor may identify and/or manage second list information 380 indicating one or more audio circuits in an activated state. For example, the first list information 370 may include the first list information of the operation 210 of FIG. 2. For example, the second list information 380 may include the second list information of the operation 220 of FIG. 2.

According to an embodiment, based on execution of the machine driver 330, the processor of the electronic device may control the plurality of audio circuits connected to the processor. In an embodiment, based on the machine driver 330, the processor may establish connections between the plurality of audio circuits and the processor. While performing initialization with respect to the plurality of audio circuits, the processor may perform binding with respect to the plurality of audio circuits connected to the processor based on the plurality of DAIs 350. For example, the processor may initialize or load device drivers (e.g., a first device driver 360-1, 360-2 to an N-th device driver 360-N) corresponding to the audio circuits indicated by the first list information and/or the machine driver 330. The processor may check whether each of the device drivers has been initialized using the machine driver 330. Checking whether each of the device drivers has been initialized by the processor may be performed for a preset number, as illustrated in the operation 230 of FIG. 2. For example, when not all of the device drivers have been initialized, the processor may initialize and/or reset the machine driver 330, and repeatedly perform checking of whether each of the device drivers has been initialized.

According to an embodiment, based on the machine driver 330, the processor of the electronic device may control audio input (e.g., recording) and/or audio output (e.g., playback of audio) with respect to the electronic device. For example, the processor may communicate with an N-th audio circuit (e.g., the N-th audio circuit 150-N of FIG. 1) corresponding to an N-th device driver 360-N, by using an N-th DAI 350-N and/or the N-th device driver 360-N. Communicating with the N-th audio circuit may include an operation of transmitting audio data to the N-th audio circuit and/or receiving audio data from the N-th audio circuit.

According to an embodiment, based on the machine driver 330, the processor of the electronic device may perform an operation of registering the sound card included in the electronic device. After all of the plurality of audio circuits connected to the processor have been switched to the activated state, the processor may register the sound card. For example, based on the machine driver 330, when at least one of the plurality of audio circuits connected to the processor maintains a deactivated state, the processor may re-perform the operation of checking the states of each of the plurality of audio circuits and/or obtaining the second list information 380 by initializing the machine driver 330. Initializing the machine driver 330 by the processor may be repeatedly performed for a preset number (e.g., the preset number in the operation 230 of FIG. 2) when at least one of the plurality of audio circuits maintains the deactivated state. When the processor identifies, based on the initialized machine driver 330, that all of the plurality of audio circuits have been switched to the activated state within a number fewer than the preset number, the processor may register the sound card without additionally initializing the machine driver 330. When at least one of the plurality of audio circuits maintains the deactivated state even after the machine driver 330 has been initialized for the preset number, the processor may generate or store log information 160 including information with respect to the at least one audio circuit.

According to an embodiment, when at least one audio circuit among the plurality of audio circuits is not initialized based on a control signal indicating initialization, the processor may repeatedly transmit the control signal to the audio circuit based on a preset number (e.g., the preset number in the operation 230 of FIG. 2). The embodiment is not limited thereto, and based on the repeatedly transmitted control signals, the processor may repeatedly attempt initialization with respect to the audio circuit. When the audio circuit is initialized based on the repeatedly transmitted control signals, the processor may perform another operation for registering the sound card. When the audio circuit is not initialized based on the repeatedly transmitted control signals, the processor may cease the registration of the sound card and determine that the audio circuit is faulty.

According to an embodiment, based on execution of the machine driver 330, the processor may identify whether the plurality of audio circuits have been initialized after transmitting the control signals for initialization to the plurality of audio circuits of the electronic device. For example, the processor having identified an audio circuit switched to the activated state based on initialization may insert the audio circuit switched to the activated state in the second list information 380. The processor may identify whether each of the plurality of audio circuits has been initialized by comparing the first list information 370 and the second list information 380. In an embodiment, the processor may repeatedly transmit the control signal for initialization based on the preset number with respect to an audio circuit included in the first list information 370 among the second list information 380 and the first list information 370. According to an embodiment, in a case in which the audio circuit is not initialized by the repeatedly transmitted control signals, the processor may determine that the audio circuit is faulty. According to an embodiment, in a case in which an audio circuit is initialized, the processor may add information with respect to the audio circuit to the second list information 380, and in a case in which an audio circuit is not initialized even after the preset number of initialization attempts, the processor may operate such that information with respect to the audio circuit is not included in the second list. According to an embodiment, the processor may perform input/output testing on the audio circuit to identify whether the audio circuit is faulty. When the audio circuit does not respond to the input/output test, the processor may determine that the audio circuit is faulty.

According to an embodiment, the processor of the electronic device may execute a function corresponding to an API related to the log information 160 based on execution of the sound debug driver 340. For example, the processor having identified at least one audio circuit in the deactivated state based on the execution of the machine driver 330 may insert the identified audio circuit in the log information 160 by executing the sound debug driver 340. Based on the execution of the sound debug driver 340, the processor may store and/or change the log information 160 in a log buffer 342 formed in the memory (e.g., the memory 120 of FIG. 1). The log buffer 342, managed by the sound debug driver 340, may be formed in volatile memory of the electronic device. For example, after the log buffer 342 is formed in the volatile memory, the log buffer 342 may be maintained in the volatile memory until a timing at which the electronic device is powered off.

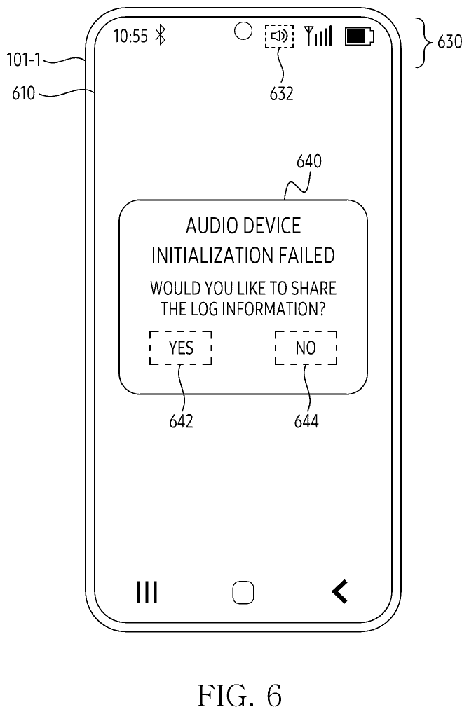

According to an embodiment, the processor of the electronic device may obtain a file including the log information 160 stored in the log buffer 342 based on execution of the log application 312. According to an embodiment, the file may be stored in non-volatile memory of the electronic device. Based on the execution of the log application 312, the processor may display a screen (e.g., a screen described with reference to FIG. 6) to guide the user of the electronic device regarding a failure in initialization of at least one audio circuit. Based on the execution of the log application 312, the processor may duplicate or move the log information 160 stored in the log buffer 342 from the volatile memory, in which the log buffer 342 is formed, to the non-volatile memory. According to an embodiment, when at least one of the plurality of audio circuits is not initialized, a sound card including all of the plurality of audio circuits may not be registered, and therefore, execution of a function related to audio may be restricted. While the execution of the function related to audio is restricted, the processor may output an error in response to an event (e.g., an API called by a software application) for executing the function. According to an embodiment, the processor having identified the error may obtain a file including the log information 160 based on the execution of the log application 312. The file may be transmitted by the processor to an external electronic device (e.g., a server and/or a repair technician's terminal) different from the electronic device.

As described above, according to an embodiment, the processor of the electronic device may attempt initialization with respect to the plurality of audio circuits based on execution of the machine driver 330. When a request to control an audio circuit that has not been initialized is identified, the processor may generate an error. For example, in a case in which at least one of the plurality of audio circuits is not initialized, the processor may cease initializing the entire plurality of audio circuits. For example, in a case in which at least one of the plurality of audio circuits is initialized, execution of all functions supported by the plurality of audio circuits may be restricted.

According to an embodiment, the processor of the electronic device may complete initialization with respect to another audio circuit that is different from an uninitialized audio circuit by using a dummy driver 362. For example, the processor having identified the at least one audio circuit maintained in the deactivated state despite initialization may connect the identified at least one audio circuit to the dummy driver 362 to complete the initialization with respect to the plurality of audio circuits. For example, connecting the dummy driver may include an operation of adding information with respect to the identified at least one audio circuit to the second list information. After connecting the dummy driver 362, the processor may register the sound card including the plurality of audio circuits. Based on the dummy driver 362, the processor may respond to a request to execute a function of the at least one audio circuit in the deactivated state. The processor having registered the sound card based on the dummy driver 362 may execute a function corresponding to another audio circuit, excluding the at least one audio circuit in the deactivated state.

As described above, according to an embodiment, the processor of the electronic device may entirely diagnose faults in all of the audio circuits by using the machine driver 330 for initialization of the plurality of audio circuits. Since all of the audio circuits are entirely diagnosed using the machine driver 330, the processor may entirely diagnose all of the audio circuits without changing the device drivers 360 corresponding to each of the audio circuits. For example, independently of whether the device drivers 360 individually support diagnosis of an audio circuit, the processor may identify whether each of the audio circuits has been initialized. Since an audio circuit is diagnosed without changing each of the device drivers 360, fragmentation generated by the device drivers 360 individually diagnosing the audio circuit may be prevented. The fragmentation may be generated as a function for diagnosing an audio circuit is implemented differently by each of the device drivers 360.

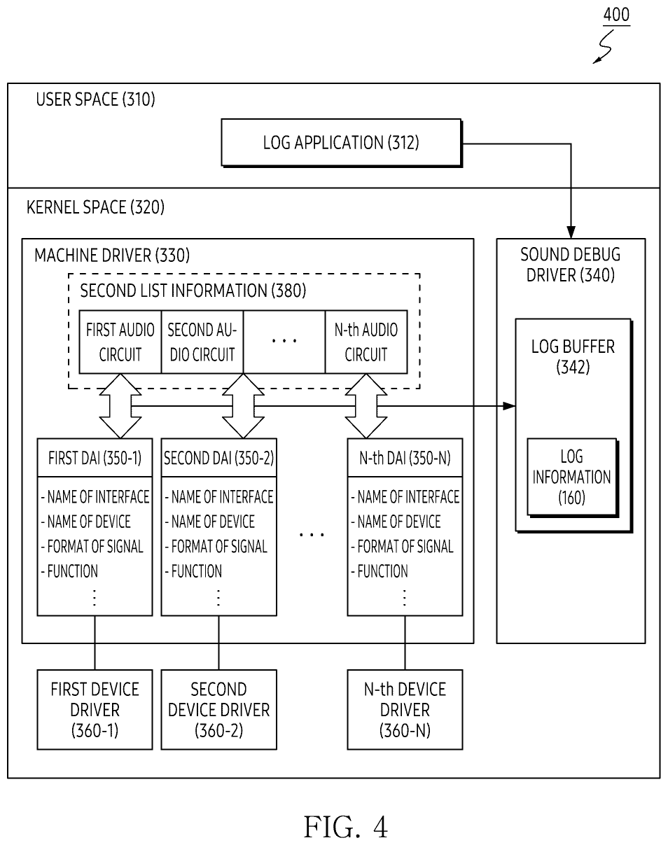

FIG. 4 illustrates an example of a block diagram for software applications executed by a processor of an electronic device according to an embodiment of the disclosure. In a block diagram 400, the electronic device 101 and/or the application processor 110 of FIG. 1 may perform at least one of operations described with reference to FIG. 4. The operation of the electronic device described with reference to FIG. 4 may be related to the operations of FIG. 2. The software applications of FIG. 4 may correspond to the software applications of FIG. 3. Among the software applications of FIG. 4, a description corresponding to the software application having the reference numeral illustrated in FIG. 3 may be omitted to avoid redundancy with the description of FIG. 3.

According to an embodiment, the processor (e.g., the application processor 110 of FIG. 1) of the electronic device performs initialization (e.g., power, GPIO, register settings) of audio circuits, and each device driver 360 is initialized, and based on execution of a machine driver 330, a connection between an audio circuit (e.g., the plurality of audio circuits 150 of FIG. 1) and an audio interface (e.g., the plurality of audio interfaces 140 of FIG. 1) may be established. The operation of establishing the connection may be referred to as binding. When initialization of an audio circuit is completed, the processor may add data with respect to the initialized audio circuit to second list information 380. The data may include a name and/or an identifier (e.g., an ID and/or a serial number) uniquely assigned to the audio circuit.

According to an embodiment, the processor of the electronic device may establish connections between the plurality of audio interfaces and the plurality of audio circuits using DAIs (e.g., a first DAI 350-1, 350-2 to an N-th DAI 350-N), which correspond to connection information related to the machine driver 330. Connection information included in a DAI may include a parameter indicating a type (e.g., I2S, SLIMbus, and/or SoundWire) of an audio interface corresponding to the DAI. The connection information included in the DAI may include a name of an audio circuit connected through the audio interface corresponding to the DAI. The connection information included in the DAI may include a parameter indicating a data format required to communicate with the audio circuit connected through the audio interface corresponding to the DAI. The connection information included in the DAI may include a function and/or an API called when communicating with the audio circuit connected through the audio interface corresponding to the DAI. For example, the connection information may include a name (or a function pointer) uniquely assigned to the function. Based on a DAI, the processor may control circuitry included in a signal path between an audio interface and an audio circuit. For example, the processor may set a clock of the circuitry to a clock indicated by the DAI. For example, the processor may control a GPIO of the circuitry based on the DAI.

In an embodiment, when an audio circuit is not initialized based on the connection, the processor may repeatedly check or attempt initialization of the audio circuit based on a preset number. In a case in which the audio circuit is initialized while repeatedly checking and/or attempting initialization of the audio circuit based on the preset number, the processor may add data with respect to the audio circuit to the second list information 380. In a case in which a state of the audio circuit is maintained in a deactivated state even after repeatedly checking and/or attempting initialization of the audio circuit based on the preset number, the processor may not add data with respect to the audio circuit to the second list information 380. Since the processor performs the above-described operation with respect to all of the plurality of audio circuits, data with respect to one or more audio circuits among the plurality of audio circuits switched to an activated state based on initialization may be accumulated in the second list information 380.

In an embodiment, the processor may identify or determine whether each of the plurality of audio circuits has been initialized by comparing the DAIs (e.g., the first DAI 350-1 to the N-th DAI 350-N) and the second list information 380. For example, the processor may search for a name of an audio circuit included in each of the DAIs in the second list information 380. In a case in which it is determined that information with respect to the audio circuits respectively included in each of the DAIs is included in the second list information 380, or in a case in which the name is identified, the processor may determine that initialization of the audio circuit corresponding to the name has been completed. In a case in which the name is not identified (e.g., checking whether the name is included in the second list) in the second list information 380, the processor may determine that initialization of the audio circuit corresponding to the name has failed. In a case in which the name is not identified in the second list information 380, the processor may determine that the audio circuitry is faulty.

As described above, according to an embodiment, the processor of the electronic device may identify at least one audio circuit maintained in the deactivated state among the plurality of audio circuits, by using information (e.g., the first DAI 350-1 to the N-th DAI 350-N) respectively corresponding to the audio interfaces respectively connecting the plurality of audio circuits to the processor. The information respectively corresponding to the audio interfaces may indicate at least one of a type of the audio interface, a name of an audio circuit connected through the audio interface, or a format of a signal interchanged through the audio interface. Based on identifying at least one audio circuit maintained in the deactivated state, the processor may add data indicating the identified at least one audio circuit to log information 160. By adding the at least one audio circuit to the log information 160, the processor may obtain a result of a diagnosis performed on the plurality of audio circuits while booting up the electronic device.

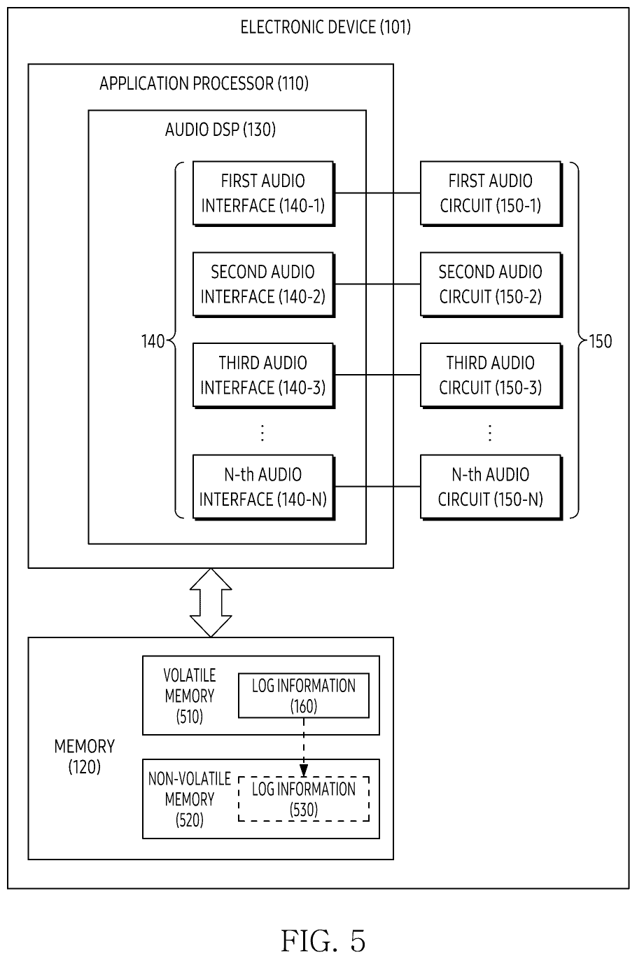

Hereinafter, with reference to FIGS. 5 and 6, an example of an operation in which the processor of the electronic device outputs the log information 160 according to an embodiment is described.

FIG. 5 illustrates an example of an operation of an electronic device for storing log information according to an embodiment of the disclosure. The electronic device 101 and/or the application processor 110 of FIG. 1 may perform an operation described with reference to FIG. 5. The operation of the electronic device 101 described with reference to FIG. 5 may be related to the operations of FIG. 2.

Referring to FIG. 5, according to an embodiment, memory 120 of the electronic device 101 may be classified into volatile memory 510 and non-volatile memory 520. The non-volatile memory 520 may include universal flash storage (UFS), a secure digital (SD) card, a solid state drive (SSD), and/or a hard disk drive (HDD). The non-volatile memory 520 may be configured to maintain stored data even when a power signal is not provided. The volatile memory 510 may include circuitry configured to maintain information while a power signal is provided, such as RAM. The embodiment is not limited thereto, and the volatile memory 510 may include virtual memory set in at least a portion of the non-volatile memory 520 by the application processor 110.

According to an embodiment, the application processor 110 of the electronic device 101 may store the log information 160 in the volatile memory 510 based on the operation described with reference to FIG. 2. As described above with reference to FIGS. 3 and 4, the application processor 110 may store the log information 160 in a log buffer (e.g., the log buffer 342 of FIG. 3 and/or FIG. 4) formed in the volatile memory 510. The log information 160 may be managed by a software application and/or system process (e.g., the sound debug driver 340 of FIG. 3) executed by the application processor 110. For example, access to the log information 160 stored in the volatile memory 510 may be permitted by the sound debug driver executed by the application processor 110.

In an embodiment, the log information 160 stored in the volatile memory 510 may be maintained in the volatile memory 510 while the electronic device 101 is powered on. According to an embodiment, when initialization of at least one of a plurality of audio circuits 150 fails, the application processor 110 may store the log information 160 and output a notification message indicating a failure of the initialization. The notification message may be outputted through a pop-up window (e.g., a toast and/or an icon) displayed through a display of electronic device 101. The embodiment is not limited thereto, and the notification message may include vibration of the electronic device 101 generated by a vibration motor. The notification message may include an electrical signal transmitted from the electronic device 101 to an external electronic device.

In an embodiment, the application processor 110 may identify an event for outputting the log information 160. The event may be generated by insertion of at least one audio circuit in the log information 160. The event may be generated by a user input for outputting the log information 160. For example, in response to an input indicating output of the log information 160, the application processor 110 may duplicate the log information 160 stored in the volatile memory 510 in the non-volatile memory 520. For example, the application processor 110 may move the log information 160, stored in the volatile memory 510, to the non-volatile memory 520, or transmit the log information 160, stored in the volatile memory 510, to the non-volatile memory 520, and/or store the log information 160, stored in the volatile memory 510, in the non-volatile memory 520. For example, based on execution of the sound debug driver 340 of FIGS. 3 and 4, the application processor 110 may store log information 530 in the non-volatile memory 520.

In an embodiment, the log information 530 stored in the non-volatile memory 520 may include text with respect to one or more audio circuits maintained in a deactivated state while booting up the electronic device 101. Table 1 indicates the text included in the log information 530 stored in the non-volatile memory 520. The embodiment is not limited thereto, and the log information 530 may include data and/or information with respect to one or more audio circuits maintained in the deactivated state based on a format different from the text.

TABLE 1

| Line Number | Text |
|---|---|
| Line 1 | [11.169826] snd-dbg: cannot find the cs35l43.18-0041 |
| Line 2 | [11.169830] snd-dbg: cannot find the cs40l26-codec |

Referring to Table 1, the text included in the log information 530 may be divided into a plurality of lines. Each of the plurality of lines may include text accumulated by the application processor 110 which identified at least one audio circuit that was not initialized due to being maintained in the deactivated state. Referring to Line 1, the application processor 110 may store text indicating that an audio circuit (e.g., amplifying circuitry) named “cs35143.18-0041” was not initialized, along with a timestamp (e.g., “11.169826”), and a name (e.g., “snd-dbg,” a name assigned to a sound debug driver) of a system process executed by the application processor 110 to record the text. The timestamp of Line 1 may indicate a timing at which the application processor 110 determined that the audio circuit named “cs35143.18-0041” is faulty. Similarly, Line 2 of the log information 530 may have been inserted by the application processor 110, which identified an audio circuit named “cs40126-codec” maintained in the deactivated state.

According to an embodiment, the application processor 110 may store the log information 530 in a preset partition and/or a preset directory of the non-volatile memory 520. For example, the application processor 110 may store the log information 530 in a directory within the non-volatile memory 520 allocated for the sound debug driver (e.g., a directory having a directory name of “/proc/snd_debug_proc/”). When the log information 530 is stored in a format of a file, the log information 530 may be stored in the non-volatile memory 520 in a form of a file having a name (e.g., “sdp_boot_log”) assigned by the sound debug driver.

As described above, according to an embodiment, the application processor 110 of the electronic device 101 may switch the plurality of audio circuits 150 connected to the application processor 110 to an activated state while booting up the electronic device 101. The application processor 110 may store a result of switching the plurality of audio circuits 150 to the activated state in the log information 160. In a case in which an audio circuit is not switched to the activated state, the application processor 110 may determine that the audio circuit is faulty. According to an embodiment, based on the log information 160 including at least one audio circuit determined to be faulty, the application processor 110 may generate and/or provide a result of diagnosing the plurality of audio circuits 150 included in electronic device 101 at a timing of booting up the electronic device 101. According to an embodiment, the operation in which the processor 110 diagnoses the plurality of audio circuits 150 may be operated at times other than the booting timing. For example, when a command requesting whether an audio circuit has been checked is received from a device outside the electronic device, or when checking of the audio circuit is delayed, the operation may proceed even after the booting is completed. Since the log information 160 is obtained while booting up the electronic device 101, an additional operation for diagnosing the plurality of audio circuits 150 (e.g., an operation of obtaining an additional log different from the log information 160) may not be required.

In an embodiment, the application processor 110 of the electronic device 101 may perform an operation (e.g., the operations described with reference to FIG. 2) for diagnosing the plurality of audio circuits 150 each time the electronic device 101 is booted. Accordingly, the application processor 110 may more quickly identify a fault, damage, and/or degradation of at least one of the plurality of audio circuits 150. The application processor 110, having identified a fault in at least one of the plurality of audio circuits 150, may display a UI for guiding the fault. Hereinafter, with reference to FIG. 6, an example of the UI displayed by the application processor 110 is described.

FIG. 6 illustrates an example of a screen displayed by an electronic device according to an embodiment of the disclosure. The electronic device 101 and/or the application processor 110 of FIG. 1 may perform an operation described with reference to FIG. 6. The operation of the electronic device 101-1 described with reference to FIG. 6 may be related to the operations of FIG. 5. Although the screen displayed by the electronic device 101-1 having a smartphone form factor is exemplarily illustrated, the embodiment is not limited thereto.

Referring to FIG. 6, according to an embodiment, the electronic device 101-1 may display, on a display 610, a screen based on a result of initialization of a plurality of audio circuits (e.g., the plurality of audio circuits 150 of FIG. 1) included in the electronic device 101-1. The display 610 may include a liquid crystal display (LCD), a plasma display panel (PDP), and/or one or more light emitting diodes (LEDs). The LED may include an organic LED (OLED). The display 610 may include a flat panel display (FPD) and/or electronic paper. In an embodiment, the display 610 may have at least partially curved shape or may have a deformable shape.

According to an embodiment, while booting up the electronic device 101-1, the electronic device 101-1 may display a visual object for notifying a deactivated state of at least one audio circuit, based on identifying the at least one audio circuit that is maintained in the deactivated state without being switched to an activated state. For example, the electronic device 101-1 may display the visual object based on execution of the log application 312 of FIG. 2. Referring to FIG. 6, the visual object may include an icon 632 and/or a pop-up window 640. For example, the electronic device 101-1 may display the icon 632 in a status bar 630, which is a region formed along a periphery of the display 610. For example, the electronic device 101-1, having identified at least one audio circuit in the deactivated state, may display the icon 632 in the status bar 630 along with other icons (e.g., an icon indicating a state of charge (SOC) of a battery and/or an icon indicating reception sensitivity of a wireless network) arranged along the periphery.

Referring to FIG. 6, the visual object for notifying the deactivated state of at least one audio circuit may include the pop-up window 640 overlapped on the screen displayed on the display 610. For example, the electronic device 101-1 may overlappingly display the pop-up window 640 on a launcher screen, a home screen, and/or an execution screen provided by a software application being executed by the electronic device 101-1. In the pop-up window 640, the electronic device 101-1 may display text (e.g., “Audio device initialization failed”) for guiding a failure in sound card registration and/or audio circuit initialization based on the at least one audio circuit in the deactivated state. Along with the text, the electronic device 101-1 may display text (e.g., “Would you like to share the log information?”) for guiding output of log information (e.g., the log information 160 of FIG. 1). In a state of displaying the text for guiding the output of the log information in the pop-up window 640, the electronic device 101-1 may display visual objects 642 and 644 for receiving an input indicating the output of the log information. Although the visual objects 642 and 644 having a form of buttons are exemplarily illustrated, the embodiment is not limited thereto.

In a state of displaying the pop-up window 640 of FIG. 6, the electronic device 101-1 may hide the pop-up window 640 displayed on the display 610 in response to an input indicating selection of the visual object 644. For example, the input indicating the selection of the visual object 644 may correspond to an input for ceasing the display of the pop-up window 640. The electronic device 101-1 may store a file (e.g., the log information 530 stored in the non-volatile memory 520 of FIG. 5) corresponding to log information (e.g., the log information 160 stored in the volatile memory 510 of FIG. 5) stored in the electronic device 101-1, in response to an input indicating selection of the visual object 642. The electronic device 101-1 may make the stored file accessible to a user of the electronic device 101-1 and/or an external electronic device. The electronic device 101-1 may further display a screen for transmitting the file through email, a messenger, and/or a wireless communication protocol for transmitting a file (e.g., WiFi direct, Bluetooth, and/or near field communication (NFC)). The electronic device 101-1 may transmit the file to an external electronic device based on the screen. According to an embodiment, sharing of the files may be performed by a preset setting (e.g., automatic transmission to a specific device upon occurrence of a problem) without displaying the pop-up window 640 related to sharing to the user.

As described above, according to an embodiment, the electronic device may perform initialization with respect to the plurality of audio circuits included in the electronic device. The initialization with respect to the plurality of audio circuits may be performed while booting up the electronic device. The electronic device may identify whether each of the plurality of audio circuits has been switched to the activated state based on the initialization. For example, by updating a list of audio circuits switched to the activated state, such as the second list information 380 of FIG. 2, the electronic device may identify whether each of the plurality of audio circuits has been switched to the activated state based on the initialization.

In an embodiment, when any one audio circuit of the plurality of audio circuits is not switched to the activated state, the electronic device may attempt to switch the audio circuit to the activated state based on a preset number. After attempts to switch the audio circuit to the activated state based on the preset number, the electronic device may determine whether to record the audio circuit in log information as an uninitialized audio circuit based on whether the audio circuit is maintained in the deactivated state. While booting up the electronic device, the electronic device may indicate, by using the log information, a list of audio circuits not switched to the activated state among the plurality of audio circuits. In an embodiment, when at least one audio circuit is not switched to the activated state, all of the plurality of audio circuits may not be accessible by the electronic device. In a state of being incapable of controlling all of the plurality of audio circuits, the electronic device may notify the user of the audio circuits maintained in the deactivated state by using the log information.

FIGS. 7A and 7B illustrate an example of a flowchart of an electronic device according to various embodiments of the disclosure. The electronic device 101 and/or the application processor 110 of FIG. 1 may perform an operation described with reference to FIGS. 7A and 7B. The operations of FIGS. 7A and 7B may be related to at least one of the operations of FIG. 2.

Referring to FIG. 7A, in operation 710, a processor (e.g., the application processor 110 of FIG. 1) of the electronic device according to an embodiment may perform initialization with respect to a plurality of audio circuits (e.g., the plurality of audio circuits 150 of FIG. 1) in a first state. According to an embodiment, the operation 710 of FIG. 7A may be performed while booting up the electronic device. According to an embodiment, the operation 710 of FIG. 7A may also be performed after the booting of the electronic device. The first state of the operation 710 may correspond to a deactivated state. The processor may include audio interfaces (e.g., the plurality of audio interfaces 140 of FIG. 1) for connecting to the plurality of audio circuits. The processor may transmit control signals for initialization to the plurality of audio circuits based on connection information (e.g., the DAIs 350 of FIG. 3) with respect to each of the audio interfaces. Each of the audio circuits that has received the control signals may be switched from the first state to a second state (e.g., an activated state).

Referring to FIG. 7A, in operation 720, the processor of the electronic device according to an embodiment may identify whether all of the plurality of audio circuits have been switched from the first state to the second state based on the initialization. In a case in which all of the plurality of audio circuits have been switched to the second state (720-YES), which is the activated state, the processor may perform operation 750. In a case in which at least one audio circuit among the plurality of audio circuits is maintained in the first state (720-NO), the processor may perform operation 730.

Referring to FIG. 7A, in the operation 750, the processor of the electronic device according to an embodiment may execute at least one of functions supported by each of the plurality of audio circuits, based on execution of a software application. In a case in which all of the plurality of audio circuits have been switched to the second state, the processor may complete the initialization with respect to the plurality of audio circuits. According to an embodiment, after the plurality of audio circuits have been switched to the second state, the processor may complete the booting of the electronic device. After completing the booting of the electronic device, the processor may execute a function related to audio indicated by a software application executed by the processor, by using the plurality of audio circuits in the second state. The function related to the audio may include audio recording, audio playback, audio encoding, and/or audio decoding.

Referring to FIG. 7A, in the operation 730, the processor of the electronic device according to an embodiment may store log information with respect to the at least one audio circuit maintained in the first state. The log information of the operation 730 may include the log information 160 of FIG. 1. The processor having identified the at least one audio circuit maintained in the first state may repeatedly check or attempt initialization of the at least one audio circuit based on a preset number or based on a lapse of a preset time. According to an embodiment of the disclosure, in a case in which the state of the at least one audio circuit is maintained in the first state after repeatedly checking or attempting initialization of the at least one audio circuit based on the preset number, the processor may perform the operation 730. According to an embodiment of the disclosure, in a case in which the state of the at least one audio circuit is maintained in the first state after repeatedly attempting initialization of the at least one audio circuit for the preset time, the processor may perform the operation 730. Based on the operation 730, the processor may obtain a list (e.g., the log information of the operation 730) of at least one audio circuit not switched to the second state.

Referring to FIG. 7A, in operation 740, the processor of the electronic device according to an embodiment may output log information based on a user input. The user input may include the user input described with reference to FIG. 6. Based on the user input, the processor may generate and/or store a file including the log information in non-volatile memory (e.g., the non-volatile memory 520 of FIG. 5). The processor may display the file to a user of the electronic device, and/or transmit the file to an external electronic device.

Referring to FIG. 7A, in a case of identifying at least one audio circuit maintained in the first state (720-NO), the processor may restrict execution of functions supported by each of the plurality of audio circuits. To execute a function supported by an audio circuit different from the at least one audio circuit in the first state, the processor may use a dummy driver (e.g., the dummy driver 362 of FIG. 3). Referring to FIG. 7B, an operation of the electronic device performed based on the dummy driver is illustrated. Among operations of FIG. 7B, descriptions of the operations 710, 720, 730, and 750 described with reference to FIG. 7A may be omitted to reduce repetition.

Referring to FIG. 7B, based on operation 710, a processor (e.g., the application processor 110 of FIG. 1) of the electronic device according to an embodiment may perform initialization with respect to a plurality of audio circuits in a first state. In operation 720, the processor of the electronic device according to an embodiment may identify whether all of the plurality of audio circuits have been switched from the first state to a second state based on the initialization. In a case in which all of the plurality of audio circuits have been switched to the second state (720-YES), the processor may perform operation 750. In a case in which at least one of the plurality of audio circuits is not switched to the second state (720-NO), the processor may perform operation 730.

Referring to FIG. 7B, in the operation 730, the processor of the electronic device according to an embodiment may store log information with respect to the at least one audio circuit maintained in the first state. Based on the operation 730, the processor may obtain log information accessible by a user of the electronic device and/or an external electronic device. After storing the log information, the processor may output the log information according to a user input, based on the operation 740 of FIG. 7A.

Referring to FIG. 7B, in operation 732, the processor of the electronic device according to an embodiment may initialize the at least one audio circuit maintained in the first state based on a dummy driver (e.g., the dummy driver 362 of FIG. 3). For example, the processor may set or bind the dummy driver as a device driver corresponding to the at least one audio circuit maintained in the first state. After the operation 732, the processor may execute the dummy driver in response to a request to execute a function of the at least one audio circuit. The dummy driver may be provided for registration of a sound card that includes the plurality of audio circuits. The dummy driver may be provided to make the plurality of audio circuits accessible by a software application executed by the processor. Referring to FIG. 7B, after initializing the at least one audio circuit based on the operation 732, the processor may perform the operation 750.

Referring to FIG. 7B, in the operation 750, the processor of the electronic device according to an embodiment may execute at least one of the functions supported by each of the plurality of audio circuits based on the execution of the software application. In a case of executing a function supported by an audio circuit switched to the second state, the processor may transmit a control signal to the audio circuit to execute the function by using a device driver corresponding to the audio circuit. In a case of executing a function supported by an audio circuit in the first state, the processor may restrict transmission of a control signal to the audio circuit by using a dummy driver. For example, based on the dummy driver, the processor may block the transmission of a control signal to the audio circuit in the first state. The processor may generate, by using the dummy driver, an error message that may be handled by the software application which requested the execution of a function with respect to the audio circuit in the first state.

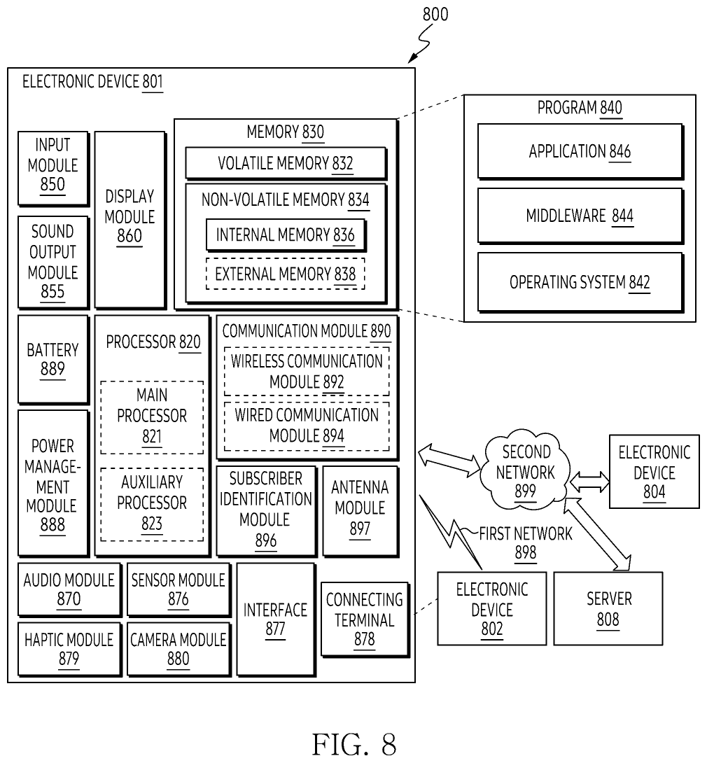

FIG. 8 is a block diagram illustrating an electronic device in a network environment according to an embodiment of the disclosure.

Referring to FIG. 8, an electronic device 801 in a network environment 800 may communicate with an electronic device 802 via a first network 898 (e.g., a short-range wireless communication network), or at least one of an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In some embodiments, at least one of the components (e.g., the connecting terminal 878) may be omitted from the electronic device 801, or one or more other components may be added in the electronic device 801. In some embodiments, some of the components (e.g., the sensor module 876, the camera module 880, or the antenna module 897) may be implemented as a single component (e.g., the display module 860).

The processor 820 may execute, for example, software (e.g., a program 840) to control at least one other component (e.g., a hardware or software component) of the electronic device 801 coupled with the processor 820, and may perform various data processing or computation. According to an embodiment, as at least part of the data processing or computation, the processor 820 may store a command or data received from another component (e.g., the sensor module 876 or the communication module 890) in volatile memory 832, process the command or the data stored in the volatile memory 832, and store resulting data in non-volatile memory 834. According to an embodiment, the processor 820 may include a main processor 821 (e.g., a central processing unit (CPU) or an application processor (AP)), or an auxiliary processor 823 (e.g., a graphics processing unit (GPU), a neural processing unit (NPU), an image signal processor (ISP), a sensor hub processor, or a communication processor (CP)) that is operable independently from, or in conjunction with, the main processor 821. For example, when the electronic device 801 includes the main processor 821 and the auxiliary processor 823, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display module 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823. According to an embodiment, the auxiliary processor 823 (e.g., the neural processing unit) may include a hardware structure specified for artificial intelligence model processing. An artificial intelligence model may be generated by machine learning. Such learning may be performed, e.g., by the electronic device 801 where the artificial intelligence is performed or via a separate server (e.g., the server 808). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output sound signals to the outside of the electronic device 801. The sound output module 855 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 may convert a sound into an electrical signal and vice versa. According to an embodiment, the audio module 870 may obtain the sound via the input module 850, or output the sound via the sound output module 855 or a headphone of an external electronic device (e.g., an electronic device 802) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device (e.g., the electronic device 802). According to an embodiment, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or electrical stimulus which may be recognized by a user via his tactile sensation or kinesthetic sensation. According to an embodiment, the haptic module 879 may include, for example, a motor, a piezoelectric element, or an electric stimulator.

The camera module 880 may capture a still image or moving images. According to an embodiment, the camera module 880 may include one or more lenses, image sensors, image signal processors, or flashes.

The power management module 888 may manage power supplied to the electronic device 801. According to an embodiment, the power management module 888 may be implemented as at least part of, for example, a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The wireless communication module 892 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the millimeter wave (mm Wave) band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the electronic device 801, an external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 864 dB or less) for implementing mMTC, or U-plane latency (e.g., 0.5 ms or less for each of downlink (DL) and uplink (UL), or a round trip of 8 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element composed of a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in the communication network, such as the first network 898 or the second network 899, may be selected, for example, by the communication module 890 (e.g., the wireless communication module 892) from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

According to various embodiments, the antenna module 897 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the electronic devices 802 or 804 may be a device of a same type as, or a different type, from the electronic device 801. According to an embodiment, all or some of operations to be executed at the electronic device 801 may be executed at one or more of the external electronic devices 802 or 804, or the server 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or mobile edge computing. In another embodiment, the external electronic device 804 may include an internet-of-things (IoT) device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

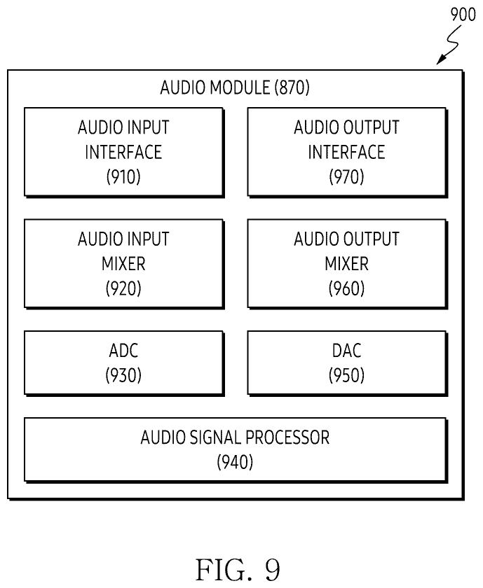

FIG. 9 is a block diagram illustrating the audio module according to an embodiment of the disclosure.

Referring to FIG. 9, in a block diagram 900, the audio module 870 may include, for example, an audio input interface 910, an audio input mixer 920, an analog-to-digital converter (ADC) 930, an audio signal processor 940, a digital-to-analog converter (DAC) 950, an audio output mixer 960, or an audio output interface 970.

The audio input interface 910 may receive an audio signal corresponding to a sound obtained from the outside of the electronic device 801 via a microphone (e.g., a dynamic microphone, a condenser microphone, or a piezo microphone) that is configured as part of the input module 850 or separately from the electronic device 801. For example, if an audio signal is obtained from the external electronic device 802 (e.g., a headset or a microphone), the audio input interface 910 may be connected with the external electronic device 802 directly via the connecting terminal 878, or wirelessly (e.g., Bluetooth™ communication) via the wireless communication module 892 to receive the audio signal. According to an embodiment, the audio input interface 910 may receive a control signal (e.g., a volume adjustment signal received via an input button) related to the audio signal obtained from the external electronic device 802. The audio input interface 910 may include a plurality of audio input channels and may receive a different audio signal via a corresponding one of the plurality of audio input channels, respectively. According to an embodiment, additionally or alternatively, the audio input interface 910 may receive an audio signal from another component (e.g., the processor 820 or the memory 830) of the electronic device 801.

The audio input mixer 920 may synthesize a plurality of inputted audio signals into at least one audio signal. For example, according to an embodiment, the audio input mixer 920 may synthesize a plurality of analog audio signals inputted via the audio input interface 910 into at least one analog audio signal.

The ADC 930 may convert an analog audio signal into a digital audio signal. For example, according to an embodiment, the ADC 930 may convert an analog audio signal received via the audio input interface 910 or, additionally or alternatively, an analog audio signal synthesized via the audio input mixer 920 into a digital audio signal.

The audio signal processor 940 may perform various processing on a digital audio signal received via the ADC 930 or a digital audio signal received from another component of the electronic device 801. For example, according to an embodiment, the audio signal processor 940 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 940 may be implemented in the form of an equalizer.

The DAC 950 may convert a digital audio signal into an analog audio signal. For example, according to an embodiment, the DAC 950 may convert a digital audio signal processed by the audio signal processor 940 or a digital audio signal obtained from another component (e.g., the processor (820) or the memory (830)) of the electronic device 801 into an analog audio signal.

The audio output mixer 960 may synthesize a plurality of audio signals, which are to be outputted, into at least one audio signal. For example, according to an embodiment, the audio output mixer 960 may synthesize an analog audio signal converted by the DAC 950 and another analog audio signal (e.g., an analog audio signal received via the audio input interface 910) into at least one analog audio signal.

The audio output interface 970 may output an analog audio signal converted by the DAC 950 or, additionally or alternatively, an analog audio signal synthesized by the audio output mixer 960 to the outside of the electronic device 801 via the sound output module 855. The sound output module 855 may include, for example, a speaker, such as a dynamic driver or a balanced armature driver, or a receiver. According to an embodiment, the sound output module 855 may include a plurality of speakers. In such a case, the audio output interface 970 may output audio signals having a plurality of different channels (e.g., stereo channels or 5.1 channels) via at least some of the plurality of speakers. According to an embodiment, the audio output interface 970 may be connected with the external electronic device 802 (e.g., an external speaker or a headset) directly via the connecting terminal 878 or wirelessly via the wireless communication module 892 to output an audio signal.

According to an embodiment, the audio module 870 may generate, without separately including the audio input mixer 920 or the audio output mixer 960, at least one digital audio signal by synthesizing a plurality of digital audio signals using at least one function of the audio signal processor 940.

According to an embodiment, the audio module 870 may include an audio amplifier (not shown) (e.g., a speaker amplifying circuit) that is capable of amplifying an analog audio signal inputted via the audio input interface 910 or an audio signal that is to be outputted via the audio output interface 970. According to an embodiment, the audio amplifier may be configured as a module separate from the audio module 870.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The electronic device 801 described with reference to FIGS. 8 and 9 may be an example of the electronic device 101 of FIG. 1. For example, the processor 820 of FIG. 8 may correspond to the application processor 110 of FIG. 1. The audio DSP 130 of FIG. 1 may correspond to the auxiliary processor 823 of FIG. 8. The plurality of audio circuits 150 of FIG. 1 may correspond to the audio module 870 described with reference to FIGS. 8 and 9.

In an embodiment, a method may be required for identifying faults in audio circuits included in an electronic device. As described above, according to an embodiment, an electronic device (e.g., the electronic device 101 of FIGS. 1 to 6) may comprise a processor (e.g., the application processor 110 of FIG. 1), a plurality of audio circuits (e.g., the plurality of audio circuits 150 of FIG. 1) connected to the processor, and memory (e.g., the memory 120 of FIG. 1) configured to store instructions. The instructions, when executed by the processor, may cause the processor to perform initialization of the plurality of audio circuits in a first state while booting up the electronic device. Each of the plurality of audio circuits may be switched to a second state different from the first state, based on the initialization. The instructions, when executed by the processor, may cause the processor to store, in the memory, log information (e.g., the log information 160 of FIG. 1) including information with respect to the identified at least one audio circuit, based on identifying, among the plurality of audio circuits, at least one audio circuit of which a state is maintained in the first state. According to an embodiment, the electronic device may output a list of at least one audio circuit, among the plurality of audio circuits, that has not been initialized.

For example, the instructions, when executed by the processor, may cause the processor to perform the initialization with respect to the plurality of audio circuits corresponding to first list information (e.g., the first list information 370 of FIG. 3) stored in the memory. The instructions, when executed by the processor, may cause the processor, in response to an audio circuit switched to the second state based on the initialization among the plurality of audio circuits, to insert, in second list information (e.g., the second list information 380 of FIG. 3) different from the first list information, the audio circuit switched to the second state.

For example, the instructions, when executed by the processor, may cause the processor to identify, using information respectively corresponding to audio interfaces (e.g., the plurality of audio interfaces 140 of FIG. 1) respectively connecting the plurality of audio circuits to the processor, the at least one audio circuit maintained in the first state among the plurality of audio circuits.

For example, the instructions, when executed by the processor, may cause the processor to identify the at least one audio circuit maintained in the first state using the information indicating at least one of a type of an audio interface, a name of an audio circuit connected through the audio interface, or a format of a signal interchanged through the audio interface.

For example, the instructions, when executed by the processor, may cause the processor to connect the identified at least one audio circuit to a dummy driver to complete the initialization with respect to the plurality of audio circuits, based on identifying the at least one audio circuit maintained in the first state.

For example, the instructions, when executed by the processor, may cause the processor to execute a function of the audio circuit in the second state based on execution of a software application.

For example, the instructions, when executed by the processor, may cause the processor to repeatedly identify, based on identifying the at least one audio circuit in the first state among the plurality of audio circuits, a state of the identified at least one audio circuit based on a preset number. The instructions, when executed by the processor, may cause the processor, while identifying the state of the at least one audio circuit for the preset number, to store, in the log information, information indicating the at least one audio circuit maintained in the first state, based on identifying that the state of the at least one audio circuit is maintained in the first state.

For example, the instructions, when executed by the processor, may cause the processor to store the log information indicating that the at least one audio circuit is different from an audio circuit accessible by the initialization, in a log buffer formed in volatile memory included in the memory. The instructions, when executed by the processor, may cause the processor to duplicate the log information in a non-volatile memory among the volatile memory and the non-volatile memory included in the memory, in response to an input indicating output of the log information.

For example, the first state may include a deactivated state, and the second state may include an activated state.

As described above, according to an embodiment, a method of an electronic device may comprise performing initialization of a plurality of audio circuits in a first state while booting up the electronic device (e.g., the operation 710 of FIGS. 7A and 7B). Each of the plurality of audio circuits of the electronic device may be switched to a second state different from the first state, based on the initialization. The method may comprise storing, in the memory, log information including information with respect to the identified at least one audio circuit, based on identifying, among the plurality of audio circuits, at least one audio circuit of which a state is maintained in the first state (e.g., the operation 730 of FIGS. 7A and 7B).

For example, the performing may comprise performing the initialization with respect to the plurality of audio circuits corresponding to first list information stored in the memory of the electronic device. The storing operation may comprise, in response to an audio circuit switched to the second state based on the initialization among the plurality of audio circuits, inserting, in second list information different from the first list information, the audio circuit switched to the second state.

For example, the storing may comprise identifying, using information respectively corresponding to audio interfaces respectively connecting the plurality of audio circuits to a processor of the electronic device, the at least one audio circuit maintained in the first state among the plurality of audio circuits.

For example, the identifying may comprise identifying the at least one audio circuit maintained in the first state using the information indicating at least one of a type of an audio interface, a name of an audio circuit connected through the audio interface, or a format of a signal interchanged through the audio interface.

For example, the method may comprise connecting the identified at least one audio circuit to a dummy driver to complete the initialization with respect to the plurality of audio circuits, based on identifying the at least one audio circuit maintained in the first state.

For example, the method may comprise executing a function of the audio circuit in the second state based on execution of a software application by the processor of the electronic device.

For example, the storing may comprise repeatedly identifying, based on identifying the at least one audio circuit in the first state among the plurality of audio circuits, a state of the identified at least one audio circuit based on a preset number. The storing may comprise, while identifying the state of the at least one audio circuit for the preset number, storing, in the log information, information indicating the at least one audio circuit maintained in the first state, based on identifying that the state of the at least one audio circuit is maintained in the first state.

For example, the storing may comprise storing the log information indicating that the at least one audio circuit is different from an audio circuit accessible by the initialization, in a log buffer formed in volatile memory of the electronic device. The method may comprise storing the log information in a non-volatile memory among the volatile memory and the non-volatile memory of the electronic device, in response to an input indicating output of the log information.

As described above, according to an embodiment, a computer-readable storage medium may include instructions. The instructions, when executed by a processor of an electronic device, may cause the processor to perform initialization of the plurality of audio circuits in a first state while booting up the electronic device. Each of the plurality of audio circuits may be switched to a second state different from the first state, based on the initialization. The instructions, when executed by the processor, may cause the processor to store, in memory of the electronic device, log information including information with respect to the identified at least one audio circuit, based on identifying, among the plurality of audio circuits, at least one audio circuit of which a state is maintained in the first state.

For example, the instructions, when executed by the processor, may cause the processor to perform the initialization with respect to the plurality of audio circuits corresponding to first list information stored in the memory. The instructions, when executed by the processor, may cause the processor, in response to an audio circuit switched to the second state based on the initialization among the plurality of audio circuits, to insert, in second list information different from the first list information, the audio circuit switched to the second state.

For example, the instructions, when executed by the processor, may cause the processor to identify, using information respectively corresponding to audio interfaces respectively connecting the plurality of audio circuits to the processor, the at least one audio circuit maintained in the first state among the plurality of audio circuits.

For example, the instructions, when executed by the processor, may cause the processor to identify the at least one audio circuit maintained in the first state using the information indicating at least one of a type of an audio interface, a name of an audio circuit connected through the audio interface, or a format of a signal interchanged through the audio interface.

For example, the instructions, when executed by the processor, may cause the processor to connect the identified at least one audio circuit to a dummy driver to complete the initialization with respect to the plurality of audio circuits, based on identifying the at least one audio circuit maintained in the first state.

For example, the instructions, when executed by the processor, may cause the processor to execute a function of the audio circuit in the second state based on execution of a software application.

For example, the instructions, when executed by the processor, may cause the processor to repeatedly identify, based on identifying the at least one audio circuit in the first state among the plurality of audio circuits, a state of the identified at least one audio circuit based on a preset number. The instructions, when executed by the processor, may cause the processor, while identifying the state of the at least one audio circuit for the preset number, to store, in the log information, information indicating the at least one audio circuit maintained in the first state, based on identifying that the state of the at least one audio circuit is maintained in the first state.

For example, the instructions, when executed by the processor, may cause the processor to store the log information in a log buffer formed in volatile memory of the electronic device. The instructions, when executed by the processor, may cause the processor to duplicate the log information in non-volatile memory among the volatile memory and the non-volatile memory of the electronic device, in response to an input indicating output of the log information.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
a plurality of audio circuits;
memory including one or more storage media storing instructions; and
at least one processor including processing circuitry communicatively coupled to the plurality of audio circuits and the memory,
wherein the instructions, when executed by the at least one processor individually or collectively, cause the electronic device to:
perform initialization of the plurality of audio circuits in a first state while booting up the electronic device, wherein each of the plurality of audio circuits are switched to a second state different from the first state based on the initialization, and
based on identifying, among the plurality of audio circuits, at least one audio circuit of which a state is maintained in the first state, store, in the memory, log information including information with respect to the identified at least one audio circuit.

2. The electronic device of claim 1, wherein the instructions, when executed by the at least one processor individually or collectively, further cause the electronic device to:
perform the initialization with respect to the plurality of audio circuits corresponding to first list information stored in the memory; and
in response to an audio circuit switched to the second state based on the initialization among the plurality of audio circuits, insert, in second list information different from the first list information, the audio circuit switched to the second state.

3. The electronic device of claim 1, wherein the instructions, when executed by the at least one processor individually or collectively, further cause the electronic device to:
identify, using information respectively corresponding to audio interfaces respectively connecting the plurality of audio circuits to the processor, the at least one audio circuit maintained in the first state among the plurality of audio circuits.

4. The electronic device of claim 3, wherein the instructions, when executed by the at least one processor individually or collectively, further cause the electronic device to:
identify the at least one audio circuit maintained in the first state using the information indicating at least one of a type of an audio interface, a name of an audio circuit connected through the audio interface, or a format of a signal interchanged through the audio interface.

5. The electronic device of claim 1, wherein the instructions, when executed by the at least one processor individually or collectively, further cause the electronic device to:
connect, based on identifying the at least one audio circuit maintained in the first state, the identified at least one audio circuit to a dummy driver to complete the initialization with respect to the plurality of audio circuits.

6. The electronic device of claim 1, wherein the instructions, when executed by the at least one processor individually or collectively, further cause the electronic device to:
execute a function of the at least one audio circuit in the second state based on execution of a software application.

7. The electronic device of claim 1, wherein the instructions, when executed by the at least one processor individually or collectively, further cause the electronic device to:
repeatedly identify, based on identifying at least one audio circuit in the first state among the plurality of audio circuits, a state of the identified at least one audio circuit based on a preset number; and
while identifying the state of the at least one audio circuit for the preset number, store, based on identifying that the state of the at least one audio circuit is maintained in the first state, information indicating the at least one audio circuit maintained in the first state, in the log information.

8. The electronic device of claim 1, wherein the instructions, when executed by the at least one processor individually or collectively, further cause the electronic device to:
store the log information indicating that the at least one audio circuit is different from an audio circuit accessible by the initialization, in a log buffer formed in volatile memory included in the memory; and
in response to an input indicating output of the log information, duplicate the log information in non-volatile memory among the volatile memory and the non-volatile memory included in the memory.

9. The electronic device of claim 1,
wherein the first state includes a deactivated state, and
wherein the second state includes an activated state.

10. A method performed by an electronic device, comprising:
performing, by the electronic device, initialization of a plurality of audio circuits in a first state while booting up the electronic device, wherein each of the plurality of audio circuits of the electronic device are switched to a second state different from the first state based on the initialization; and
based on identifying, among the plurality of audio circuits, at least one audio circuit of which a state is maintained in the first state, storing, by the electronic device, in memory of the electronic device, log information including information with respect to the identified at least one audio circuit.

11. The method of claim 10,
wherein the performing comprises:
performing the initialization with respect to the plurality of audio circuits corresponding to first list information stored in the memory, and
wherein the storing comprises:
in response to an audio circuit switched to the second state based on the initialization among the plurality of audio circuits, inserting, in second list information different from the first list information, the audio circuit switched to the second state.

12. The method of claim 10, wherein the storing comprises:
identifying, using information respectively corresponding to audio interfaces respectively connecting the plurality of audio circuits to a processor of the electronic device, the at least one audio circuit maintained in the first state among the plurality of audio circuits.

13. The method of claim 12, wherein the identifying comprises:
identifying the at least one audio circuit maintained in the first state using the information indicating at least one of a type of an audio interface, a name of an audio circuit connected through the audio interface, or a format of a signal interchanged through the audio interface.

14. The method of claim 10, further comprises:
connecting, based on identifying the at least one audio circuit maintained in the first state, the identified at least one audio circuit to a dummy driver to complete the initialization with respect to the plurality of audio circuits.

15. One or more non-transitory computer readable storage media storing one or more computer programs including computer-executable instructions that, when executed by one or more processors of an electronic device individually or collectively, cause the electronic device to perform operations, the electronic device including memory and a plurality of audio circuits, the operations comprising:
performing initialization of the plurality of audio circuits in a first state while booting up the electronic device, wherein each of the plurality of audio circuits are switched to a second state different from the first state based on the initialization; and
based on identifying, among the plurality of audio circuits, at least one audio circuit of which a state is maintained in the first state, storing, in the memory, log information including information with respect to the identified at least one audio circuit.

16. The one or more non-transitory computer readable storage media of claim 15, wherein the operations further comprising:
performing the initialization with respect to the plurality of audio circuits corresponding to first list information stored in the memory; and
in response to an audio circuit switched to the second state based on the initialization among the plurality of audio circuits, inserting, in second list information different from the first list information, the audio circuit switched to the second state.

17. The one or more non-transitory computer readable storage media of claim 15, the operations further comprising:
identifying, using information respectively corresponding to audio interfaces respectively connecting the plurality of audio circuits to the one or more processors, the at least one audio circuit maintained in the first state among the plurality of audio circuits.

18. The one or more non-transitory computer readable storage media of claim 17, the operations further comprising:
identifying the at least one audio circuit maintained in the first state using the information indicating at least one of a type of an audio interface, a name of an audio circuit connected through the audio interface, or a format of a signal interchanged through the audio interface.

19. The one or more non-transitory computer readable storage media of claim 15, the operations further comprising:
connecting, based on identifying the at least one audio circuit maintained in the first state, the identified at least one audio circuit to a dummy driver to complete the initialization with respect to the plurality of audio circuits.

20. The one or more non-transitory computer readable storage media of claim 15, the operations further comprising:
executing a function of the at least one audio circuit in the second state based on execution of a software application.
